(19) United States
(12) Patent Application Publication
(10) Pub. No.: US 2024/0219649 A1
(43) Pub. Date: Jul. 4, 2024

(54) MPO FIBER-OPTIC ADAPTER

(71) Applicant: CLOUD LIGHT TECHNOLOGY LIMITED, Hong Kong (HK)

(72) Inventor: CHIEH-TSE HUANG, Hong Kong (HK)

(21) Appl. No.: 18/091,409

(22) Filed: Dec. 30, 2022

(51) Int. Cl. G02B 6/38

(52) U.S. Cl. CPC G02B 6/3869; G02B 6/3825; G02B 6/3881

(57) ABSTRACT

An MPO fiber-optic adapter includes a casing and an enclosing clamp. The casing has a first end and a second end along a ferrule insertion direction. A guiding unit is disposed at the second end of the casing and includes a supporting bottom plate and two guiding walls. The two guiding walls and the supporting bottom plate jointly define a guiding groove. The enclosing clamp has a top plate and two enclosing elements. The top plate covers the top side of the guiding unit. The two enclosing elements enclose the two guiding walls and part of the supporting bottom plate. The enclosing elements each include a sidewall and an engaging portion. The sidewall connects to the top plate and the engaging portion. At least two engagement features are defined on an outward side of the supporting bottom plate. The two engaging portions are engaged with the engagement features, respectively.

### BACKGROUND OF THE INVENTION

### 1. Field of the Invention

The present disclosure relates to an adapter of a fiber-optic connector, and in particular to an MPO fiber-optic adapter.

### 2. Description of the Related Art

Multi-Fiber Push-On (MPO for short) fiber-optic connectors are suitable for use in high-density fiber-optic networks. MPO fiber-optic connectors are effective in allocating high-density optical fibers to a limited space and thus play an important role in the communication industry confronted with ever-increasing data traffic.

An MPO fiber-optic connector usually comprises therein a ferrule and an MPO fiber-optic adapter. However, when the ferrule is mounted on the MPO fiber-optic adapter, the engagement therebetween is rarely tight enough; thus, deflection is likely to occur, thereby leading to misalignment of plug and receptacle and the resultant damage to the ferrule.

### BRIEF SUMMARY OF THE INVENTION

In view of the aforesaid drawbacks of the conventional MPO fiber-optic connectors, it is an objective of the disclosure to provide an MPO fiber-optic adapter capable of firmly engaging with the ferrule and thus fixing the ferrule in place.

In order to achieve the above and other objectives, the disclosure provides an MPO fiber-optic adapter comprising: a casing having a first end and a second end along a ferrule insertion direction, with a guiding unit disposed at the second end of the casing, the guiding unit comprising a supporting bottom plate and two guiding walls, the two guiding walls extending in the ferrule insertion direction to define a guiding groove together with the supporting bottom plate; and an enclosing clamp having a top plate and two enclosing elements, the top plate covering a top side of the guiding unit, the two enclosing elements having two ends aligned in a width direction of the top plate and connected to the top plate, thereby enclosing the two guiding walls and part of the supporting bottom plate, the width direction being perpendicular to the ferrule insertion direction, the two enclosing elements each comprising a sidewall and an engaging portion, with the sidewall connected to the top plate and the engaging portion. At least two engagement features variable in a height direction are defined on an outward side of the supporting bottom plate and engaged with the two engaging portions, respectively, with the height direction being perpendicular to the ferrule insertion direction and the width direction.

In an embodiment of the disclosure, the top plate has a hollowed-out portion in rectangular shape, wherein a first pushing element and two second pushing elements are disposed in the hollowed-out portion of the top plate, the first pushing element being disposed at a first edge of the hollowed-out portion and exerting a thrust toward the first end of the casing, and the two second pushing elements being disposed at two opposing second edges of the hollowed-out portion, respectively, and exerting a thrust toward each other, with the first edge being parallel to the width direction, and the two second edges being parallel to the ferrule insertion direction.

In an embodiment of the disclosure, the first pushing element and the two second pushing elements are integrally formed with the top plate.

In an embodiment of the disclosure, the first pushing element and the two second pushing elements are springs mounted in the hollowed-out portion.

In an embodiment of the disclosure, the engaging portions are parallel to the top plate.

In an embodiment of the disclosure, the engagement features are in the number of at least two.

In an embodiment of the disclosure, the engagement features are in the number of at least four and are arranged in two rows and in the ferrule insertion direction.

Therefore, the MPO fiber-optic adapter of the disclosure is advantageous in that the enclosing clamp encloses and engages with the guiding unit from three sides; thus, the degree of freedom of the ferrule is restricted in three mutually perpendicular directions, namely the ferrule insertion direction, width direction and height direction, to thereby ensure position precision of optical planes and prevent deflection. In addition, the distance between a mechanical plane and an optical plane is well controlled to ensure that coupling precision and yield are high.

### BRIEF DESCRIPTION OF THE DRAWINGS

FIG. 1A is a schematic perspective view of an MPO fiber-optic adapter according to an embodiment of the disclosure.

FIG. 1B is a schematic perspective view of the MPO fiber-optic adapter taken from another angle according to an embodiment of the disclosure.

FIG. 2 is an exploded view of the MPO fiber-optic adapter according to an embodiment of the disclosure.

FIG. 3 is a schematic perspective view of an enclosing clamp according to an embodiment of the disclosure.

FIG. 4 is an exploded view of the MPO fiber-optic adapter according to an embodiment of the disclosure.

### DETAILED DESCRIPTION OF THE INVENTION

The disclosure is hereunder illustrated with specific embodiments, depicted with accompanying drawings, and described in detail below to enable persons skilled in the art to gain insight into the objectives, features, and advantages of the disclosure. The disclosure can be implemented or applied in accordance with any other variant embodiments. Details presented herein may be modified or changed from different perspectives and for different applications without departing from the spirit of the disclosure. The embodiments presented below are further descriptive of the technical features of the disclosure rather than restrictive of the claims of the disclosure.

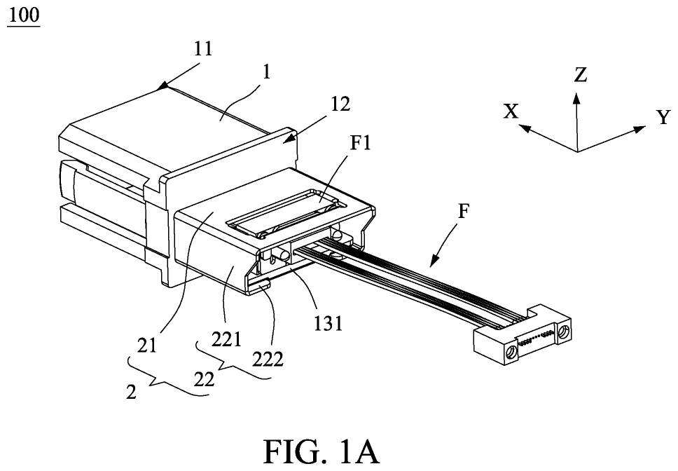

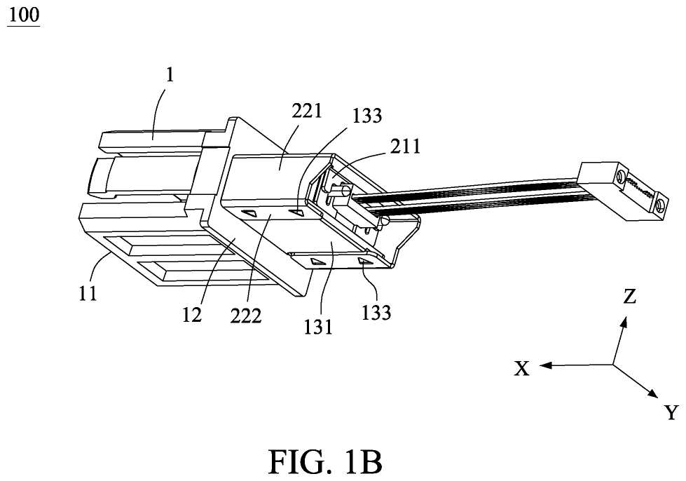

Referring to FIG. 1A through FIG. 4, an MPO fiber-optic adapter 100 provided according to an embodiment of the disclosure comprises a casing 1 and an enclosing clamp 2.

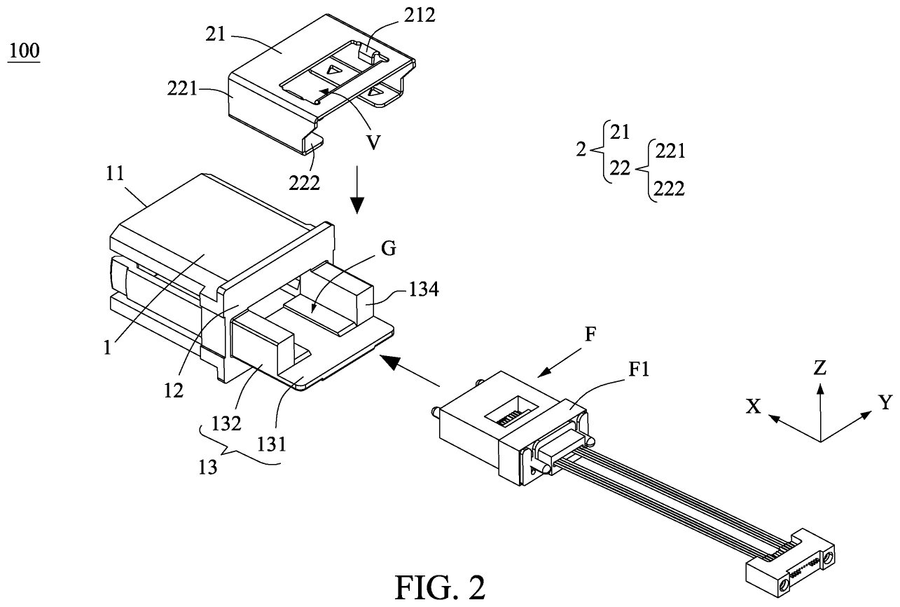

As shown in FIG. 2, the casing 1 has a first end 11 and a second end 12 along a ferrule insertion direction (X direction). A guiding unit 13 is disposed at the second end 12 of the casing 1. The guiding unit 13 comprises a supporting bottom plate 131 and two guiding walls 132. The two guiding walls 132 extend in the ferrule insertion direction to thereby define a guiding groove G together with the supporting bottom plate 131. The width of the guiding groove G matches the width of an insertion portion (front end) of a ferrule F so that the guiding groove G holds the front end of the ferrule F. During an assembly process, the front end of the ferrule F slides in the ferrule insertion direction into the guiding unit 13 from the guiding groove G.

The enclosing clamp 2 has a top plate 21 and two enclosing elements 22. As shown in FIG. 1A, the top plate 21 covers the top side of the guiding unit 13. When the enclosing clamp 2 encloses the ferrule F, the top plate 21 is attached to the top side of the ferrule F. The two enclosing elements 22 have two ends aligned in a width direction (Y direction) of the top plate 21 and connected to the top plate 21, thereby enclosing the two guiding walls 132 and part of the supporting bottom plate 131. The width direction is perpendicular to the ferrule insertion direction. Two enclosing elements 22 each comprise a sidewall 221 and an engaging portion 222. The sidewall 221 is connected to the top plate 21 and the engaging portion 222. The sidewalls 221 are attached to the outward (i.e., facing away from the guiding groove G) sides of the two guiding walls 132. The enclosing clamp 2 is made of a metal plate that is resilient to not only keep the ferrule F centrally aligned but also provide the ferrule F with a persistent thrust toward an optical port direction.

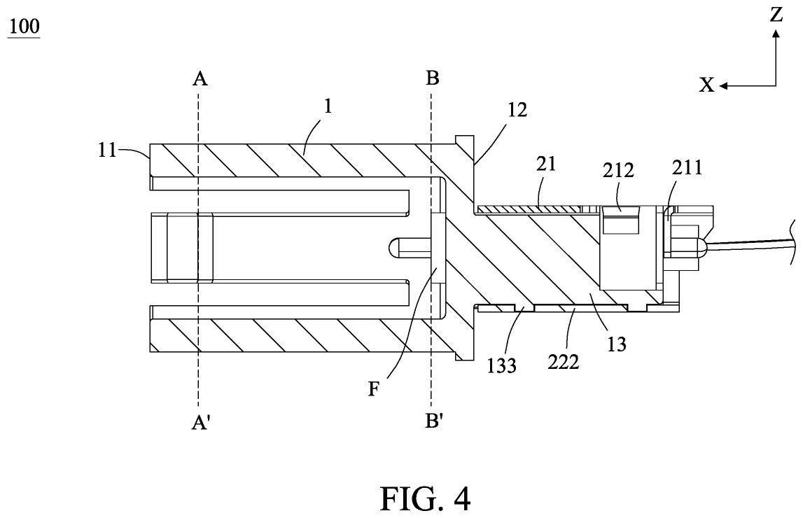

As shown in FIG. 1B and FIG. 4, at least two engagement features 133 variable in a height direction (Z direction) are defined on an outward side of the supporting bottom plate 131. The engagement features 133 are bumps or dents lying in the height direction and being in geometric shapes, where the height direction is perpendicular to the ferrule insertion direction and width direction. In this embodiment, the engagement features 133 are triangular prism in shape, but the disclosure is not limited thereto. The two engaging portions 222 have matching features 222a that are engaged with the engagement features 133, respectively. The matching features 222a correspond in shape and number to the engagement features 133.

The guiding groove G and the guiding unit 13 at the second end 12 of the casing 1 allow the ferrule F to be inserted in the ferrule insertion direction into the guiding groove G and smoothly attached to an end side 134 of the guiding unit 13. The enclosing clamp 2 encloses and engages with the guiding unit 13 from three sides; thus, the degree of freedom of the ferrule F is restricted in three mutually perpendicular directions, namely the ferrule insertion direction, width direction and height direction (i.e., X direction, Y direction, and Z direction) to thereby ensure position precision of optical planes and prevent deflection. Furthermore, the distance between line A-A′ (indicative of a mechanical plane) and line B-B′ (indicative of an optical plane) is well controlled to ensure that coupling precision and yield are high.

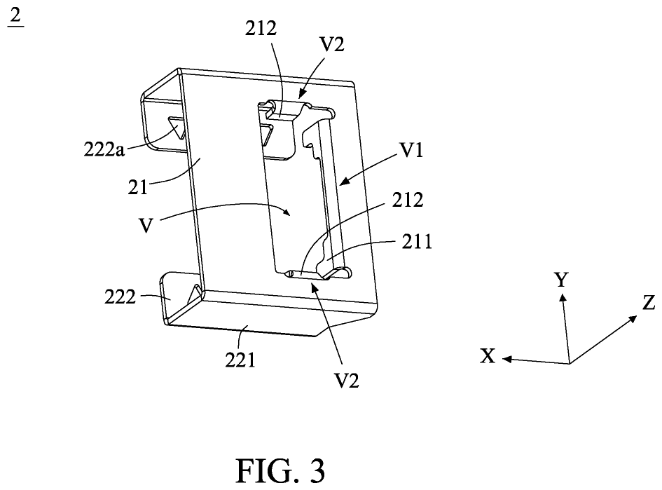

As shown in FIG. 3, the top plate 21 has a hollowed-out portion V in rectangular shape. A first pushing element 211 and two second pushing elements 212 are disposed in the hollowed-out portion V of the top plate 21. The first pushing element 211 is disposed at a first edge V1 of the hollowed-out portion V and exerts a thrust toward the first end 11 of the casing 1, where the first edge V1 is parallel to the width direction (Y direction). The two second pushing elements 212 are disposed at two opposing second edges V2 of the hollowed-out portion V, respectively, and exert a thrust toward each other, where the two second edges V2 are parallel to the ferrule insertion direction (X direction). The hollowed-out portion V holds a raised portion F1 of the ferrule F; thus, a first pushing element 211 and two second pushing elements 212 exert a thrust on the raised portion F1 in the ferrule insertion direction (X direction) and the width direction (Y direction), respectively, to keep the ferrule F centrally aligned and thereby allow the ferrule F to be attached to the second end 12 of the casing 1 to a greater extent.

Furthermore, the first pushing element 211 and the two second pushing elements 212 are integrally formed with the top plate 21. The first pushing element 211 and the two second pushing elements 212 may be part of a metal plate. After the hollowed-out portion V has been cut out of the top plate 21, part of the material initially lying within the hollowed-out portion V is bent by a pressing process or an equivalent process to thereby form the first pushing element 211 and the two second pushing elements 212; however, the disclosure is not limited thereto. In a variant embodiment, the first pushing element 211 and the two second pushing elements 212 are springs mounted in the hollowed-out portion V by adhesion or a fitting process. Therefore, all types of components that are resilient and capable of exerting a thrust in a specific direction can function as the first pushing element 211 and the second pushing elements 212 of the disclosure.

As shown in FIG. 1A and FIG. 3, the engaging portions 222 are parallel to the top plate 21. Preferably, the engaging portions 222 and the top plate 21 are parallel to the X-Y plane, and the two sidewalls 221 are perpendicularly connected to the engaging portions 222 and the top plate 21, so as for the guiding unit 13 to be enclosed from three sides.

Furthermore, the engagement features 133 are in the number of at least two and are disposed at two ends aligned in the width direction, respectively. Preferably, in this embodiment, as shown in FIG. 1B, the engagement features 133 are in the number of at least four and are arranged in two rows and in the ferrule insertion direction to be firmly engaged with the engaging portions 222.

The invention is disclosed above by embodiments. However, persons skilled in the art should understand that the embodiments are illustrative of the invention only, but shall not be interpreted as restrictive of the scope of the invention. Hence, all equivalent modifications and replacements made to the embodiments shall be deemed falling within the scope of the invention. Accordingly, the legal protection for the invention shall be defined by the appended claims.

What is claimed is:

1. An MPO fiber-optic adapter comprising:
a casing having a first end and a second end along a ferrule insertion direction, with a guiding unit disposed at the second end of the casing, the guiding unit comprising a supporting bottom plate and two guiding walls, the two guiding walls extending in the ferrule insertion direction to define a guiding groove together with the supporting bottom plate; and
an enclosing clamp having a top plate and two enclosing elements, the top plate covering a top side of the guiding unit, the two enclosing elements having two ends aligned in a width direction of the top plate and connected to the top plate, thereby enclosing the two guiding walls and part of the supporting bottom plate, the width direction being perpendicular to the ferrule insertion direction, the two enclosing elements each comprising a sidewall and an engaging portion, with the sidewall connected to the top plate and the engaging portion,
wherein at least two engagement features variable in a height direction are defined on an outward side of the supporting bottom plate and engaged with the two engaging portions, respectively, with the height direction being perpendicular to the ferrule insertion direction and the width direction.

2. The MPO fiber-optic adapter of claim 1, wherein the top plate has a hollowed-out portion in rectangular shape, wherein a first pushing element and two second pushing elements are disposed in the hollowed-out portion of the top plate, the first pushing element being disposed at a first edge of the hollowed-out portion and exerting a thrust toward the first end of the casing, and the two second pushing elements being disposed at two opposing second edges of the hollowed-out portion, respectively, and exerting a thrust toward each other, with the first edge being parallel to the width direction, and the two second edges being parallel to the ferrule insertion direction.

3. The MPO fiber-optic adapter of claim 2, wherein the first pushing element and the two second pushing elements are integrally formed with the top plate.

4. The MPO fiber-optic adapter of claim 2, wherein the first pushing element and the two second pushing elements are springs mounted in the hollowed-out portion.

5. The MPO fiber-optic adapter of claim 1, wherein the engaging portions are parallel to the top plate.

6. The MPO fiber-optic adapter of claim 1, wherein the engagement features are in the number of at least two.

7. The MPO fiber-optic adapter of claim 6, wherein the engagement features are in the number of at least four and are arranged in two rows and in the ferrule insertion direction.
